(19) United States
(12) Patent Application Publication
(10) Pub. No.: US 2005/0167211 A1
(43) Pub. Date: Aug. 4, 2005

(54) Electric brake caliper with load equalization

(76) Inventors: John B. Hageman, Vandalia, OH (US); Harald Klode, Centerville, OH (US); Thomas D. Hewer, Dayton, OH (US)

Correspondence Address: Michael D. Smith, Esq.;Delphi Technologies, Inc., Legal Staff, M/C 480-410-202, P.O. Box 5052, Troy, MI, 48007, US

(21) Appl. No.: 10/770,929

(22) Filed: Feb. 3, 2004

(51) Int. Cl. F16D 55/02

(52) U.S. Cl. 188/71.9

(57) ABSTRACT

An electric caliper assembly for a brake system is provided. The electric caliper assembly includes a housing defining a bore with a bridge extending therefrom, a first and a second friction element and a brake rotor disposed under the bridge, a piston having a flat outer surface for engaging the first friction element, an electric motor connected to a ballscrew mechanism for applying an axial load to the piston, a cap connected to the ball screw mechanism, and a universal connection between a spherical surface of the piston and a complimentary spherical surface of the cap for allowing a swiveling movement of the piston relative to the assembly. This swiveling movement allows the piston to engage the first friction element perpendicularly so that the load may be transmitted from the piston to the first friction element over the entire surface of the piston, maximizing the efficiency of the assembly.

### FIELD OF THE INVENTION

The subject invention relates generally to a brake system for a motor vehicle. More specifically, the subject invention relates to the brake system having an electric caliper assembly.

### BACKGROUND OF THE INVENTION

Various types of brake systems are known for use in automotive vehicles. Such brake systems include, for example, hydraulic brake systems, anti-lock brake systems and electric brake systems. A typical electric brake system (also referred to as a “brake by wire” system) utilizes an electric caliper assembly that incorporates an electric motor for driving a gear system positioned within the electric caliper assembly. The gear system, in turn, drives an inner brake pad against a brake rotor disc of a vehicle. An outer brake pad mounted to the electric caliper assembly is positioned on an opposite side of the brake rotor disc. During braking, the inner brake pad is forced against the brake rotor disc and a resulting reactionary load pulls the outer break pad into engagement with the opposite side of the brake rotor disc. Engagement of the inner and outer brake pads will slow or stop rotation of the brake rotor disc, and in turn, slow the vehicle, or hold the vehicle in a fixed position.

The electric motor provides a load that the electric caliper assembly increases to achieve the necessary load to operate the electric brake system. A ballscrew mechanism typically increases the initial load by acting in combination with a gear system. The load is applied to a face of a piston that engages the inner brake pad. The efficiency and durability of the electric caliper assembly is dependent on the centering of the reactionary load from the inner and outer brake pads and the brake rotor disc. If the electric caliper assembly does not engage the inner brake pad perpendicularly, the inner and outer brake pads may wear unevenly. This uneven wear may cause deflection of the electric caliper assembly at high loads resulting in a sideloading in the electric caliper assembly. Referring to Prior Art FIG. 1, the inner brake pad IP engages a piston P at a non-perpendicular angle. The load L is applied by the electric caliper assembly. The offset reactionary load O is generated by the braking action and is unevenly distributed across a portion of the piston. The uneven distribution of the offset reactionary load O results in the axial load and the reactionary load being applied along differing axis. This creates a torque within the electric caliper assembly that causes the sideloading. The sideloading has a negative effect on the efficiency and performance of the electric caliper assembly, and may possibly cause it to bind during operation. The loss of efficiency may result in a significant reduction in the capability of the electric caliper assembly to transmit the load to the inner and outer brake pads.

Accordingly, there is a need for a caliper assembly for an electric brake system that will perpendicularly engage a misaligned inner brake pad and evenly distribute a load applied thereon, minimizing sideloading of the assembly, thereby maximizing the efficiency of the electric brake system.

### BRIEF SUMMARY OF THE INVENTION AND ADVANTAGES

The subject invention provides an electric caliper assembly for a brake system. The electric caliper assembly includes a first friction element and a piston having a surface for engaging the first friction element. An actuator for applying an axial load to the piston. The electric caliper assembly further includes a universal connection positioned between the piston and the actuator. The universal connection allows the piston to swivel relative to the actuator so that the piston may engage the first friction element perpendicularly and evenly distribute the load to the first friction element over the entire surface of the piston.

Accordingly, the subject invention overcomes the disadvantages of the prior art by providing a caliper assembly for an electric brake system that allows the loads transmitted between the piston and the first friction element to be evenly distributed over the face of the piston, minimizing the sideloading of the actuator and reducing the possibility of the assembly binding during operation, thereby increasing the efficiency of the assembly.

### BRIEF DESCRIPTION OF THE SEVERAL VIEWS OF THE DRAWINGS

Advantages of the subject invention will be readily appreciated, as the same becomes better understood by reference to the following detailed description when considered in connection with the accompanying drawing wherein:

FIG. 2 is a cross-sectional view of an electric caliper assembly for a brake system;

FIG. 3 is a cross-sectional load diagram of the first friction element and the piston swiveling to perpendicularly engage the first friction element and showing the resultant equalized load;

FIG. 4 is a cross-sectional view of a load distribution device; and

FIG. 5 is an enlarged fragmentary cross-sectional view of the electric caliper assembly shown in FIG. 1.

### DETAILED DESCRIPTION OF THE INVENTION

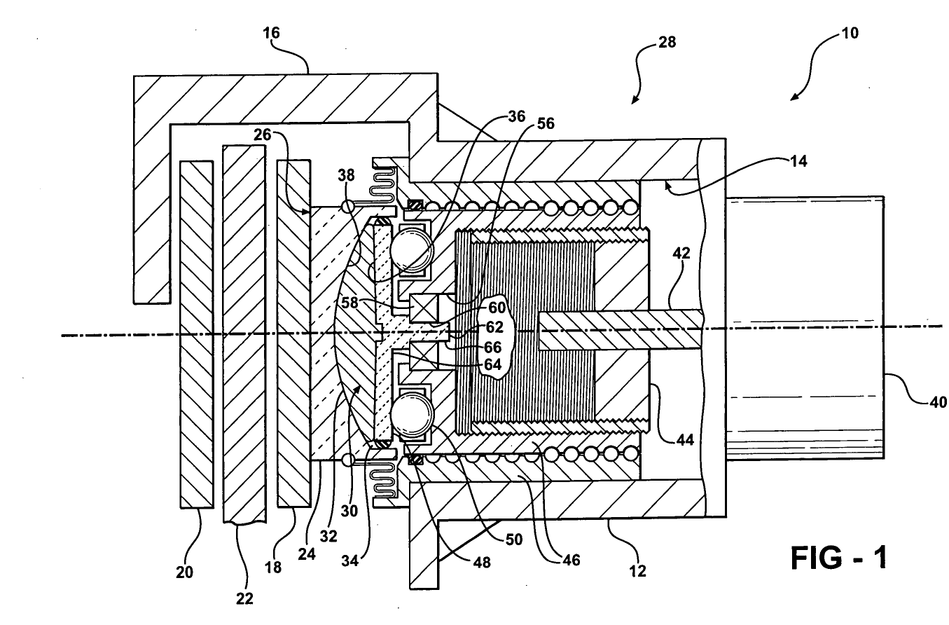

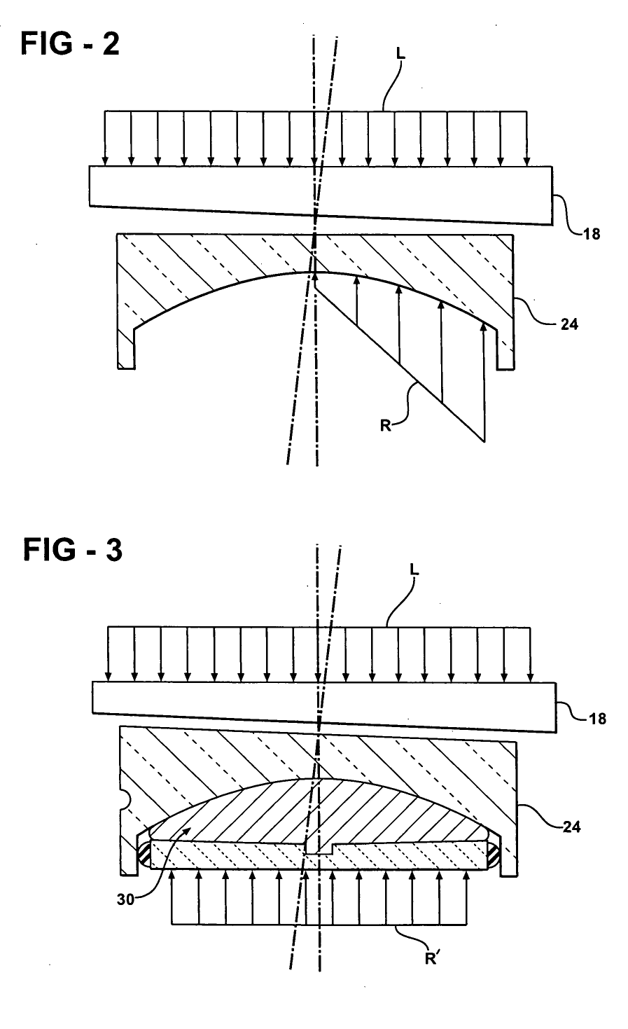

Referring to the Figures, wherein like numerals indicate like parts throughout the several views, an electric caliper assembly for a brake system is generally shown at 10. Referring to FIG. 2, the electric caliper assembly 10 includes a housing 12 defining a bore 14. A bridge 16 extends from the housing 12. A first 18 and a second 20 friction element and a brake rotor 22 are disposed under the bridge 16. A piston 24 having a flat outer surface 26 engages the first friction element 18. An actuator 28 applies an axial load to the piston 24. The electric caliper assembly further includes a universal connection 30 positioned between the piston 24 and the actuator 28 for allowing a swiveling movement of the piston 24 relative to the actuator 28. This swiveling movement allows the piston 24 to engage the first friction element 18 perpendicularly so that the load may be transmitted from the piston 24 to the first friction element 18 over the entire surface 26 of the piston 24, maximizing the efficiency of the assembly 10.

The actuator 28 includes an electric motor 40 having a rotatable output shaft 42 and a gear system 44 rotatably driven by the output shaft 42. A ball screw mechanism 46 increases the load from the electric motor and converts the rotational movement of the gear system 44 into an axial output movement in response to actuation of the electric motor 40. A cap 48 distributes the load from the ballscrew mechanism 46 to the universal connection 30. A bearing 50 rotatably supports the cap 48 and transmits the load from the ballscrew mechanism 46 to the cap 48.

Referring to FIG. 5, a front edge 52 of the actuator 28 defines an annular channel 54 in which the bearing 50 is seated. The annular channel 54 includes an inner flange 56 that defines an interior opening in which a bushing 58 is disposed therein. The bushing 58 includes a circular aperture 60 that is concentric with the bore 14. The cap 48 includes a shaft 62 journaled to fit the aperture 60 and extends axially through the aperture 60 from an inner surface 64 of the cap 48 toward the actuator 28. The cap 48 is rotatable secured to the bushing 58 by a snap ring 66. Thus, the cap 48 is able to rotate about the bore 14 and the piston 24 is able to swivel in relation to the actuator 28 minimizing the sideloading of the assembly 10 and reducing the possibility of the assembly 10 binding while in operation.

The piston includes an annular flange 74 extending axially beyond the cap 48 from an outer edge of the piston 76 toward the actuator 28. The cap 48 may include a semicircular outer edge that slideably engages the annular flange 74 for radially piloting the piston 24 as the piston 24 swivels to engage the first friction element 18.

Alternatively, the cap 48 may include a semicircular annular ring 78 that is attached to an outer edge of the cap 80. The annular ring 78 slideably engages the annular flange 74 for radially piloting the piston 24 as the piston 24 swivels to engage the first friction element 18. The annular ring 78 is preferably manufactured from a material having a low coefficient of friction.

As the piston 24 applies the load to the first friction element 18, the first 18 and second 20 friction elements engage the brake rotor 22 in a clamping action slowing or holding the brake rotor 22. When the first friction element 18 is not perpendicular to the actuator 28, a resultant offset load is generated from the clamping action and is directed back through the assembly toward the actuator 28. Referring to FIG. 3, the universal connection 30 allows the piston 24 to swivel and engage the first friction element 18 perpendicularly allowing the resultant load R to be evenly distributed over the entire surface 26 of the piston 24, minimizing any sideloading on the actuator 28.

Referring to FIG. 2, the universal connection 30 includes a deformable load distribution device 32 presented between the actuator 28 and the piston 24 for evenly distributing the load between the piston 24 and the actuator 28 as the piston 24 swivels to engage the first friction element 18. The load distribution device 32 fills a cavity 34 having a shape defined between the piston 24 and the actuator 28. As the piston 24 swivels to engage the first friction element 18, the shape of the cavity 34 will change accordingly. The load distribution device 32 therefore deforms to accommodate the varying shape of the cavity 34. By deforming to fill the cavity 34, the load distribution device 32 allows for the constant and even distribution of the load between the piston 24 and the actuator 28.

The load distribution device 32 is substantially incompressible and has a variable thickness. As the load distribution device 32 deforms, the thickness of the load distribution device 32 varies accordingly. The incompressibility of the load distribution device 32 allows the load to be evenly distributed over the piston 24 regardless of the varying thickness of the load distribution device 32.

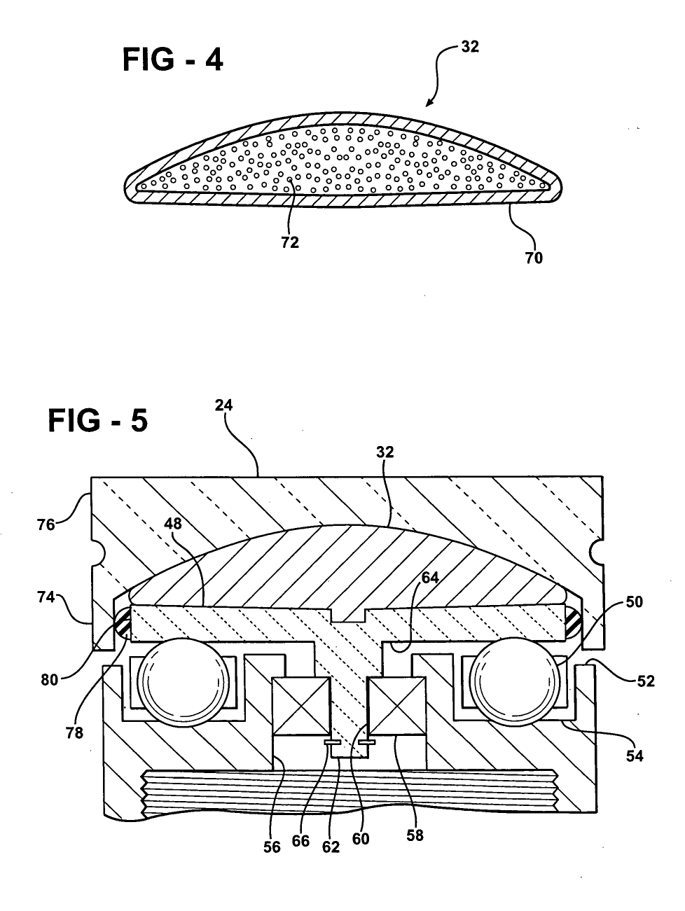

Preferably, the load distribution device is one of either a solid elastomer such as a fluorosilicone rubber or a flexible container filled with a flowable material, and is made of materials having a high thermal resistance. Referring to FIG. 4, the flexible container 70 may be manufactured from a cloth or an elastomer material. The flowable material 72 filling the flexible container 70 may be a liquid having a high specific gravity or a plurality of solid particles. The load distribution device 32 has a high thermal resistance for insulating the actuator 28 from a heat gradient generated from the clamping action of the first 18 and second 20 friction elements engaging the brake rotor disc 22.

Referring to FIG. 5, a spherical surface 36 on the actuator 28 opposes a complimentary spherical surface 38 on the piston 24 for supporting the load distribution device 32. These opposing spherical surfaces 36, 38 will allow the load distribution device 32 to deform as the piston 24 swivels to engage the first friction element 18, as well as urge the load distribution device 32 back into a neutral position upon releasing the load.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electric caliper assembly for a brake system comprising:
a first friction element;
a piston for engaging said first friction element;
an actuator for applying an axial load to said piston; and
a universal connection between said piston and said actuator for allowing a swiveling movement of said piston relative to said actuator for evenly distributing said load to said first friction element to minimize sideloading of said assembly.

2. An assembly as set forth in claim 1 wherein said universal connection includes a deformable load distribution device presented between said actuator and said piston for evenly distributing said load over said piston as said piston swivels to engage said first friction element.

3. An assembly as set forth in claim 2 wherein said universal connection includes a spherical surface on said actuator opposing a complimentary spherical surface on said piston for supporting said load distribution device.

4. An assembly as set forth in claim 3 wherein said load distribution device is incompressible.

5. An assembly as set forth in claim 3 wherein said load distribution device has a thermal resistance for insulating said assembly from a heat gradient generated by said first friction element.

6. An assembly as set forth in claim 3 wherein said load distribution device is a solid elastomer.

7. An assembly as set forth in claim 3 wherein said load distribution device is a flexible container filled with a flowable material.

8. An assembly as set forth in claim 7 wherein said flexible container is a cloth material.

9. An assembly as set forth in claim 7 wherein said flexible container is an elastomer material.

10. An assembly as set forth in claim 7 wherein said flowable material is a liquid having a high specific gravity.

11. An assembly as set forth in claim 7 wherein said flowable material is a plurality of solid particles.

12. An assembly as set forth in claim 3 wherein said actuator includes a circular cap disposed between said actuator and said load distribution device for distributing said load therebetween.

13. An assembly as set forth in claim 12 wherein said piston includes an annular flange axially extending beyond said cap from an outer edge of said piston toward said actuator.

14. An assembly as set forth in claim 13 wherein said cap includes an outer edge for slideably engaging said annular flange for radially piloting said piston as said piston swivels to engage said first friction element.

15. An assembly as set forth in claim 14 wherein said outer edge of said cap is semicircular.

16. An assembly as set forth in claim 13 wherein said cap includes a semicircular annular ring attached to an outer edge of said cap for slideably engaging said annular flange for radially piloting said piston as said piston swivels to engage said first friction element.

17. An assembly as set forth in claim 16 wherein said annular ring has a low coefficient of friction.

18. An assembly as set forth in claim 12 wherein said actuator includes a bearing disposed between said actuator and said cap for rotatably supporting said cap and transmitting said load therebetween.

19. An assembly as set forth in claim 18 wherein said actuator includes a front edge defining an annular channel.

20. An assembly as set forth in claim 19 wherein said bearing is seated in said annular channel.
